(19) United States
(12) Patent Application Publication
(10) Pub. No.: US 2026/0061763 A1
(43) Pub. Date: Mar. 5, 2026

(54) INKJET HEAD UNIT AND SUBSTRATE TREATING APPARATUS

(71) Applicant: SEMES CO., LTD., Chungcheongnam-do (KR)

(72) Inventors: Bo Ram Chan SUNG, Chungcheongnam-do (KR); Jin Woo YANG, Gyeonggi-do (KR); Dong Yun LEE, Chungcheongnam-do (KR)

(21) Appl. No.: 19/234,269

(22) Filed: Jun. 11, 2025

(30) Foreign Application Priority Data
Aug. 29, 2024 (KR) 10-2024-0116885

(51) Int. Cl. B41J 25/34; B41J 3/407; B41J 25/00; B41J 29/38

(52) U.S. Cl. CPC B41J 25/34; B41J 3/407; B41J 25/001; B41J 29/38; B41J 2202/20

(57) ABSTRACT

A substrate treating apparatus that can simplify the work and equipment for head alignment includes: an inkjet head unit configured to eject a substrate treating liquid; and a gantry unit configured to support the inkjet head unit, wherein the inkjet head unit comprises: a plurality of heads each provided with a plurality of nozzles; and a plurality of packs in each of which the heads are installed such that the nozzles are exposed, and within each of the packs, a plurality of heads are provided in a first direction and a second direction, in which the nozzles are arranged.

### CROSS-REFERENCE TO RELATED APPLICATION

This application claims priority from Korean Patent Application No. 10-2024-0116885 filed on August. 29, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to an inkjet head unit and a substrate treating apparatus.

### 2. Description of the Related Art

The manufacture of a display may include a plurality of treating processes for forming light-emitting elements on a substrate (e.g., a transparent glass), and as one of the treating processes, there is an inkjet printing process for forming a film or a pattern by ejecting droplets of ink, which serves as a substrate treating liquid, onto the substrate.

To eject ink onto a substrate, an inkjet printing apparatus, serving as a substrate treating apparatus, is installed in a display manufacturing factory, and the inkjet printing process is performed on the substrate by the inkjet printing apparatus.

In addition, when manufacturing a large display, tens to hundreds of heads are provided in a single substrate treating apparatus to shorten the processing time. Furthermore, when an inkjet printing system is used in the process of printing a color filter having three colors of red (R), green (G), and blue (B), tens of heads must be used for each color to shorten the processing time.

When using an inkjet printing apparatus as a substrate treating apparatus, to ensure that ink ejected from heads is accurately applied to each desired position, the nozzles of each head must be provided at positions corresponding to the respective dots, i.e., at designed positions, at the time of ink ejection, and if the nozzle positions deviate from the designed positions, the ink is sprayed onto incorrect positions. Thus, when a plurality of heads are used, the alignment of the heads becomes an important factor for quality and productivity.

### SUMMARY

One objective of the present disclosure is to provide an inkjet head unit and a substrate treating apparatus that can simplify the work and equipment for head alignment.

The objectives of the present disclosure are not limited to those mentioned above, and other objectives not explicitly stated will be clearly understood by those skilled in the art based on the following description.

According to an aspect of the present disclosure, a substrate treating apparatus includes: an inkjet head unit configured to eject a substrate treating liquid; and a gantry unit configured to support the inkjet head unit, wherein the inkjet head unit comprises: a plurality of heads each provided with a plurality of nozzles; and a plurality of packs in each of which the heads are installed such that the nozzles are exposed, and within each of the packs, a plurality of heads are provided in a first direction and a second direction, in which the nozzles are arranged.

According to another aspect of the present disclosure, a substrate treating apparatus includes an inkjet head unit configured to eject a substrate treating liquid provided as ink; and a gantry unit configured to support the inkjet head unit and provided as a single gantry, wherein the inkjet head unit comprises: a plurality of heads each provided with a plurality of nozzles; a plurality of packs in each of which the heads are installed such that the nozzles are exposed; a carriage plate on which the packs are provided and which is installed on the gantry unit; head holders configured to fix the packs to the carriage plate; and a head alignment unit configured to rotate first ends of the packs relative to second ends of the packs to adjust placement of the packs in a first rotational direction, the packs are arranged in three columns on the carriage plate and offset from each other based on center lines of the heads in a second direction, in which the nozzles are arranged, and comprise: a first pack provided in a first column; a second pack provided in a second column; and a third pack provided in a third column, the heads are provided in two rows and three or more columns within each of the packs, and multiple heads located in the same row within each of the packs are arranged side by side in the first direction without being offset, and provided in up to five columns, nozzles of a last row or subsequent row of heads in an M-th row within the first pack on the carriage plate overlap with nozzles of a first row or front row of heads in an M-th row within the second pack, nozzles of a first row or preceding row of heads in a second row within the first pack on the carriage plate overlap with nozzles of a last row or rear row of heads in a first row within the third pack, and the head alignment unit comprises: a first motor unit including a first motor whose length is adjustable in the first direction and configured to push or pull the first pack from a first end of the first pack in the first direction to rotate the first pack; a second motor unit including a second motor whose length is adjustable in the first direction, and a third motor whose length is adjustable in the second direction and configured to push or pull the second pack from a first end of the second pack in the first direction to rotate the second pack; and a third motor unit including a fourth motor whose length is adjustable in the first direction and a fifth motor whose length is adjustable in the second direction and configured to push or pull the third pack from a first end of the third pack in the first direction to rotate the third pack.

According to still another aspect of the present disclosure, an inkjet head unit provided in a substrate treating apparatus includes a plurality of heads each provided with a plurality of nozzles; and a plurality of packs in each of which the heads are installed such that the nozzles are exposed, wherein a plurality of heads are provided within each of the packs along a first direction and a second direction, in which the nozzles are arranged.

The inkjet head unit and substrate treating apparatus according to the present disclosure can simplify the work for head alignment by allowing heads to be aligned in units of packs without the need to align the individual heads. In addition, since the number of head holders can be reduced, the load of the inkjet head unit supported by a gantry unit can be reduced, thereby making it possible to simplify the substrate treating apparatus (equipment), such as reducing restrictions that conventionally require the use of dual gantries, and facilitating the installation work for the substrate treating apparatus.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a plan view illustrating a substrate treating apparatus according to some embodiments of the present disclosure;

FIG. 2 is a perspective view illustrating a state where a head alignment unit is provided in an inkjet head unit of a substrate treating apparatus according to a first embodiment of the present disclosure;

FIG. 3 is a plan view illustrating the state where the head alignment unit is provided in the inkjet head unit of the substrate treating apparatus according to the first embodiment of the present disclosure;

FIG. 4 is a plan view for explaining heads of the inkjet head unit of the substrate treating apparatus according to the first embodiment of the present disclosure;

FIG. 5 is a plan view for explaining the alignment of a first pack of the inkjet head unit of the substrate treating apparatus according to the first embodiment of the present disclosure;

FIG. 6 is a plan view for explaining the alignment of a second pack of the inkjet head unit of the substrate treating apparatus according to the first embodiment of the present disclosure;

FIG. 7 is a plan view for explaining the alignment of a third pack of the inkjet head unit of the substrate treating apparatus according to the first embodiment of the present disclosure;

FIG. 8 is a plan view for explaining a stain phenomenon of an inkjet head unit according to a comparative example;

FIG. 9 is a plan view illustrating the inkjet head unit according to the comparative example; and

FIG. 10 is a front view for explaining the inkjet head unit of the substrate treating apparatus according to the first embodiment of the present disclosure and the inkjet head unit according to the comparative example.

### DETAILED DESCRIPTION

Embodiments of the present disclosure will hereinafter be described in detail with reference to the accompanying drawings. Advantages and features of the present disclosure, and methods of achieving them, will become apparent with reference to the embodiments to be described below together with the accompanying drawings. However, the present disclosure is not limited to the embodiments set forth below and may be embodied in various different forms. The embodiments are provided only to complete the present disclosure and to fully convey the scope of the invention to one of ordinary skill in the art, and the present disclosure is defined only by the scope of the appended claims. Throughout the specification, like reference numerals refer to like elements.

The terminology used herein is for the purpose of describing embodiments only and is not intended to be limiting of the present disclosure. In this specification, the singular forms include plural forms as well, unless the context clearly indicates otherwise. It should also be understood that the terms “comprises” and/or “comprising,” when used herein, specify the presence of stated features, integers, steps, operations, elements, and/or components but do not preclude the presence or addition of one or more other features, integers, steps, operations, elements, components, and/or groups thereof.

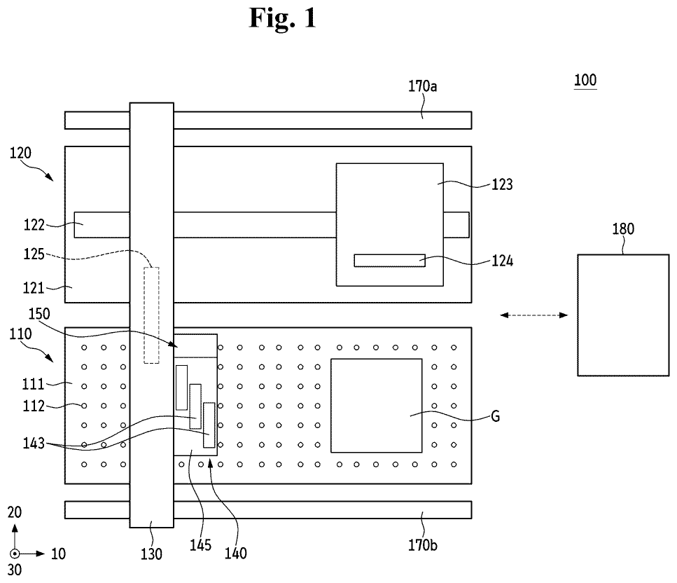

FIG. 1 is a plan view illustrating a substrate treating apparatus according to some embodiments of the present disclosure.

Referring to FIG. 1, a substrate treating apparatus 100 may include a process treating unit 110, a maintenance unit 120, a gantry unit 130, an inkjet head unit 140, a substrate treating liquid supply unit 150, a head alignment unit 160, and a controller 180.

The substrate treating apparatus 100 is for treating a substrate G (e.g., transparent glass) used in the manufacture of a display device. The substrate treating apparatus 100 may perform a printing process on the substrate G by ejecting a substrate treating liquid onto the substrate G using the inkjet head unit 140.

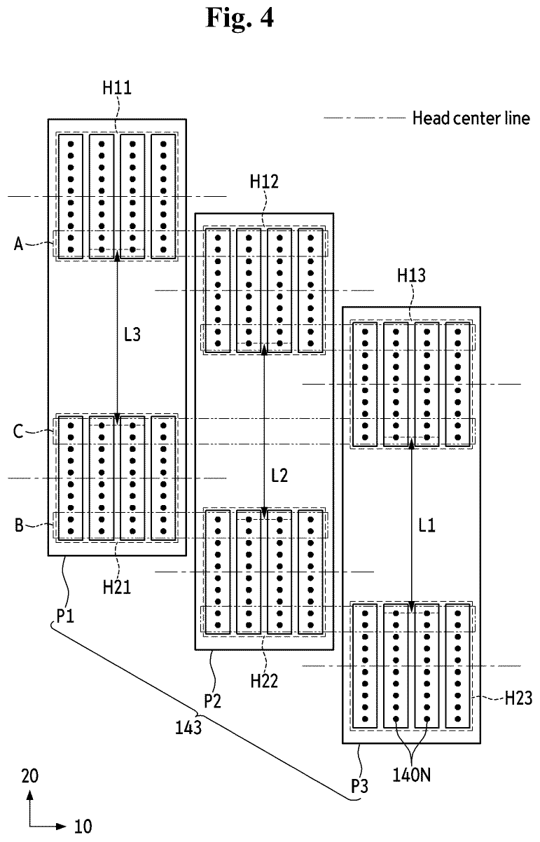

The substrate treating apparatus 100 may use a substrate treating liquid. Here, the substrate treating liquid may be ink as a chemical liquid used for printing treatment of the substrate G. In other words, the substrate treating apparatus 100 may be provided as an inkjet printing apparatus that forms a color filter on the substrate G using ink. The substrate treating apparatus 100 may perform pixel printing on the substrate G using the substrate treating liquid, and may be provided as a circulation-type inkjet printing facility to prevent nozzles (“140N” in FIG. 4) from clogging due to the substrate treating liquid, but is not limited thereto.

The process treating unit 110 supports the substrate G while the substrate G is being printed using the substrate treating liquid. The process treating unit 110 may support the substrate G using a non-contact method. For example, the process treating unit 110 may support the substrate G by levitating the substrate G using air, but the present disclosure is not limited thereto. Alternatively, the process treating unit 110 may support the substrate G using a contact method.

The process treating unit 110 may move the substrate G while supporting the substrate G using air. For example, the process treating unit 110 may include a first stage 111 and air holes 112.

The first stage 111 may be provided to allow the substrate G to be placed thereon. The air holes 112 may be formed to penetrate the first stage 111. A plurality of air holes 112 may be formed within a printing zone on the first stage 111.

The air holes 112 may spray air in the upward direction of the first stage 111, i.e., a third direction 30. Through this, the air holes 112 may float the substrate G placed on the first stage 111.

Although not illustrated, the process treating unit 110 may further include a gripping unit and a guide rail. When the substrate G moves along the longitudinal direction of the first stage 111, i.e., a first direction 10, the gripping unit may grip the substrate G to prevent the substrate G from departing from the first stage 111. When the substrate G moves, the gripping unit may move in the same direction as the substrate G while gripping the substrate G along the guide rail. The gripping unit and the guide rail may be provided outside the first stage 111.

The maintenance unit 120 measures ejection positions (i.e., dotting points) and/or the ejection status of the substrate treating liquid on the substrate G. The maintenance unit 120 may measure the ejection positions and/or the ejection status of the substrate treating liquid for each of a plurality of nozzles provided in the inkjet head unit 140, and the relevant measurement results may be provided to the controller 180.

For example, the maintenance unit 120 may include a second stage 121, a third guide rail 122, a first plate 123, a calibration board 124, and a camera module 125.

The second stage 121 may be arranged parallel to the first stage 111. The second stage 121 may include a maintenance zone on its upper surface. The second stage 121 may be provided to have the same size as the first stage 111. Alternatively, the second stage 121 may be provided to have a smaller or larger size than the first stage 111.

The third guide rail 122 guides the movement path of the first plate 123. The third guide rail 122 may be provided on the second stage 121 as at least one line along the longitudinal direction of the second stage 121, i.e., along the first direction 10. The third guide rail 122 may be implemented as, for example, a linear motor guide system.

Although not illustrated, the maintenance unit 120 may further include a fourth guide rail. Like the third guide rail 122, the fourth guide rail guides the movement path of the first plate 123 and may be provided on the second stage 121 as at least one line along the width direction of the second stage 121, i.e., a second direction 20.

The first plate 123 may move on the second stage 121 along the third guide rail 122 and/or the fourth guide rail. The first plate 123 may move parallel to the substrate G along the third guide rail 122, and may approach or move away from the substrate G along the fourth guide rail.

The calibration board 124 is for measuring the ejection position of the substrate treating liquid on the substrate G. The calibration board 124 may be installed on the first plate 123 to measure the ejection position of the substrate treating liquid, and may include a plurality of alignment marks, a ruler, etc., and may be provided along the longitudinal direction of the first plate 123, i.e., along the first direction 10.

Meanwhile, although not illustrated, the calibration board 124 may also be provided at a position close to the inkjet head unit 140 together with measuring equipment (e.g., a camera module 125) installed to check the ejection status of the substrate treating liquid. For example, the calibration board 124 and the measuring equipment may be installed on the gantry unit 130.

The camera module 125, which is an optical device, is for acquiring image information on the substrate G. The image information acquired by the camera module 125 may include information on position alignment of the substrate G before printing, whether the substrate treating liquid is being ejected during printing, the ejection position of the substrate treating liquid, the ejection amount of the substrate treating liquid, the ejection area of the substrate treating liquid, and/or dotting accuracy. Meanwhile, the camera module 125 may acquire not only image information on the substrate G, onto which the substrate treating liquid has been ejected, but also information on the calibration board 124 and provide the acquired information to the controller 180.

The camera module 125 may acquire image information on the substrate G in real time during the treatment of the substrate G. The camera module 125 may acquire image information by capturing an image of the substrate G in the first direction 10, in which case, the camera module 125 may include a line scan camera. The camera module 125 may also acquire image information by capturing an image of the substrate G in units of regions of a predetermined size, in which case, the camera module 125 may include an area scan camera.

The camera module 125 may be attached to the bottom surface or a side surface of the gantry unit 130 to acquire image information on the substrate G, onto which the substrate treating liquid has been ejected, but the present disclosure is not limited thereto. The camera module 125 may also be attached to a side surface of the inkjet head unit 140. Various modifications are possible such as fixedly or movably installing the camera module 125.

The gantry unit 130 supports the inkjet head unit 140. The gantry unit 130 may be provided above the first and second stages 111 and 121 so that the inkjet head unit 140 may eject the substrate treating liquid onto the substrate G.

The gantry unit 130 may be provided on the first and second stages 111 and 121 with the width direction of the first and second stages 111 and 121, i.e., the second direction 20, as its longitudinal direction. The gantry unit 130 may move in the longitudinal direction of the first and second stages 111 and 121, i.e., in the first direction 10, along a first guide rail 170a and a second guide rail 170b. The first and second guide rails 170a and 170b may be provided outside the first and second stages 111 and 121 along the longitudinal direction of the first and second stages 111 and 121, i.e., along the first direction 10.

Although not illustrated, the substrate treating apparatus 100 may further include a gantry moving unit. The gantry moving unit slides the gantry unit 130 along the first and second guide rails 170a and 170b. The gantry moving unit may be installed inside the gantry unit 130 and may include a drive device such as a motor.

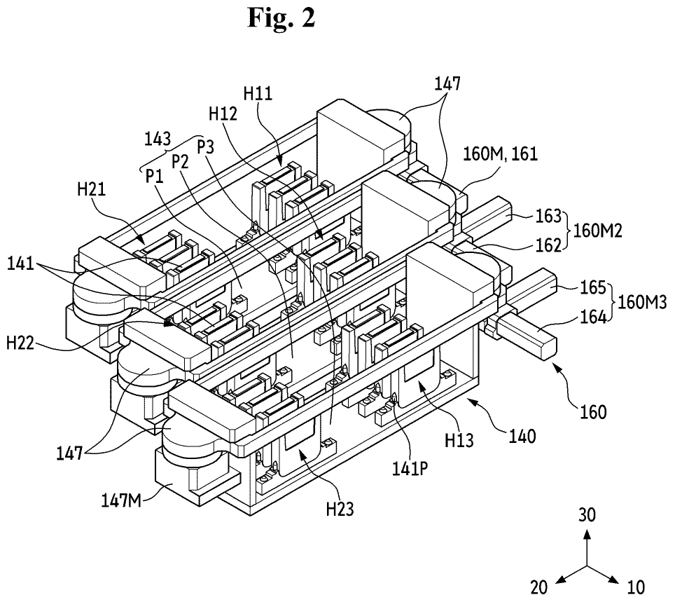

Before explaining the inkjet head unit 140 and the head alignment unit 160 with reference to FIGS. 2 through 7, the function and position of the inkjet head unit 140 will hereinafter be described briefly. The inkjet head unit 140 ejects the substrate treating liquid in the form of droplets onto the substrate G. The inkjet head unit 140 may be installed on a side surface of the gantry unit 130, but is not limited thereto.

The inkjet head unit 140 may move along the longitudinal direction of the gantry unit 130, i.e., along the second direction 20, to be positioned at a desired point on the substrate G, but the present disclosure is not limited thereto. The inkjet head unit 140 may also move along the height direction of the gantry unit 130, i.e., along the third direction 30, and may rotate clockwise or counterclockwise.

Although not illustrated, the substrate treating apparatus 100 may further include an inkjet head moving unit. The inkjet head moving unit may linearly move or rotate the inkjet head unit 140, and may include a drive device such as a motor.

The inkjet head unit 140 may also be fixedly installed on the gantry unit 130. In this case, the gantry unit 130 may be provided to be movable.

The substrate treating liquid supply unit 150 may be provided as a reservoir for supplying the substrate treating liquid to the inkjet head unit 140. For example, the substrate treating liquid supply unit 150 may be installed on the gantry unit 130 and may include a storage tank (not illustrated) and a pressure control module (not illustrated).

The storage tank stores the substrate treating liquid, and the pressure control module controls internal pressure of the storage tank. The storage tank may supply an appropriate amount of the substrate treating liquid to the inkjet head unit 140 based on the pressure provided by the pressure control module.

The substrate treating liquid supply unit 150 may be configured as an integrated module with the inkjet head unit 140. For example, the inkjet head unit 140 and the substrate treating liquid supply unit 150 may be arranged on a front surface of the gantry unit 130, and the substrate treating liquid supply unit 150 may be positioned at a higher level than the inkjet head unit 140. However, the present disclosure is not limited to this example.

The substrate treating liquid supply unit 150 may also be configured as a separate module from the inkjet head unit 140. For example, the inkjet head unit 140 and the substrate treating liquid supply unit 150 may be provided separately on the front surface and rear surface, respectively, of the gantry unit 130.

The controller 180 controls the operation of each component (e.g., the process treating unit 110, the gantry unit 130, the inkjet head unit 140, and the substrate treating liquid supply unit 150) of the substrate treating apparatus 100. For example, the controller 180 may control the operations of the air holes 112 of the process treating unit 110, the camera module 125 of the maintenance unit 120, the gantry unit 130, the inkjet head unit 140, and the pressure control module of the substrate treating liquid supply unit 150.

The controller 180 may be implemented as a computer or a server including a process controller, a control program, an input module, an output module, a display module, and/or a memory module.

The process controller may include a microprocessor for performing a control function for each component constituting the substrate treating apparatus 100. The control program may perform various processing operations of the substrate treating apparatus 100 under the control of the process controller. The memory module stores various programs, i.e., processing recipes, to execute various processing operations of the substrate treating apparatus 100 according to various data and processing conditions.

In addition, the controller 180 may also perform a maintenance function for the inkjet head unit 140. For example, based on measurement results from the maintenance unit 120, the controller 180 may correct the ejection position of the substrate treating liquid for each nozzle provided in the inkjet head unit 140 or detect any defective nozzles (i.e., nozzles that do not properly eject the substrate treating liquid) among the nozzles and perform a cleaning operation for such defective nozzles.

The inkjet head unit 140 and the head alignment unit 160 will hereinafter be described.

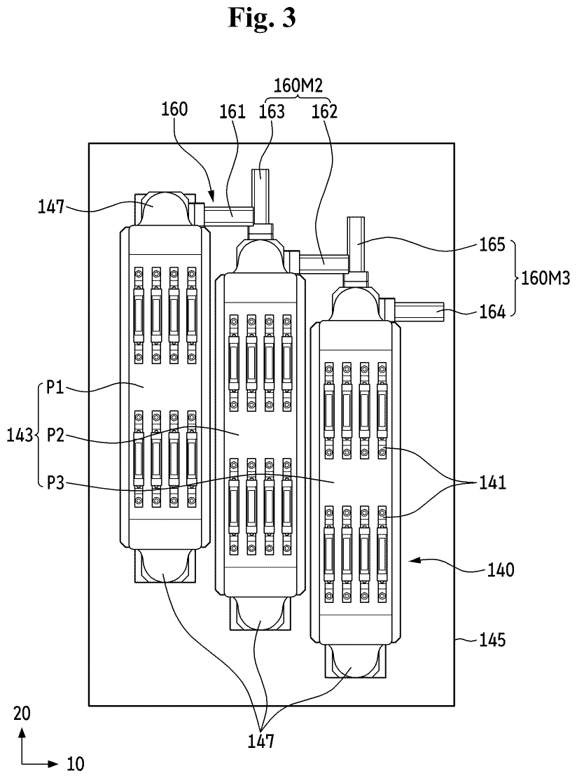

FIG. 2 is a perspective view illustrating a state where a head alignment unit 160 is provided in an inkjet head unit 140 of a substrate treating apparatus 100 according to a first embodiment of the present disclosure, and FIG. 3 is a plan view illustrating the state where the head alignment unit 160 is provided in the inkjet head unit 140 of the substrate treating apparatus 100. In addition, FIG. 4 is a plan view for explaining heads 141 of the inkjet head unit 140 of the substrate treating apparatus 100.

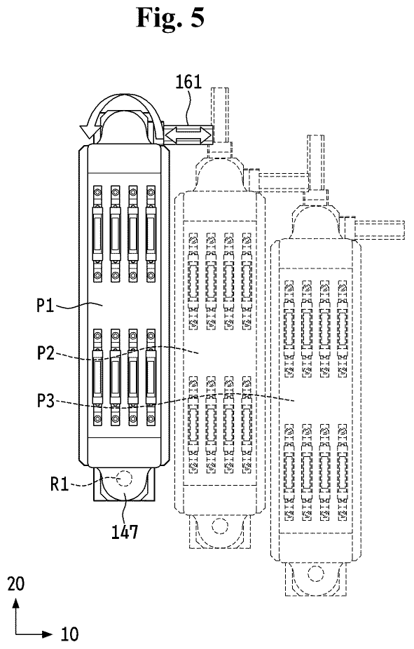

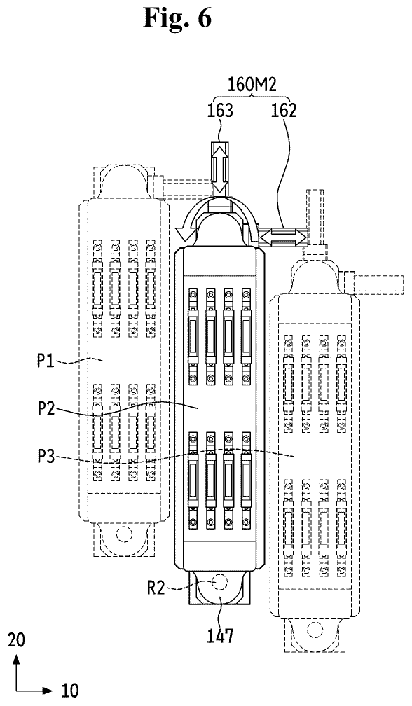

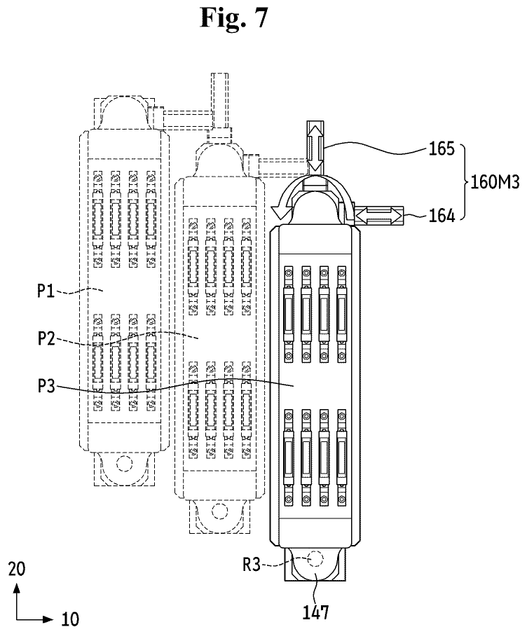

Further, FIG. 5 is a plan view for explaining the alignment of a first pack P1 of the inkjet head unit 140 of the substrate treating apparatus 100, FIG. 6 is a plan view for explaining the alignment of a second pack P2 of the inkjet head unit 140 of the substrate treating apparatus 100, and FIG. 7 is a plan view for explaining the alignment of a third pack P3 of the inkjet head unit 140 of the substrate treating apparatus 100.

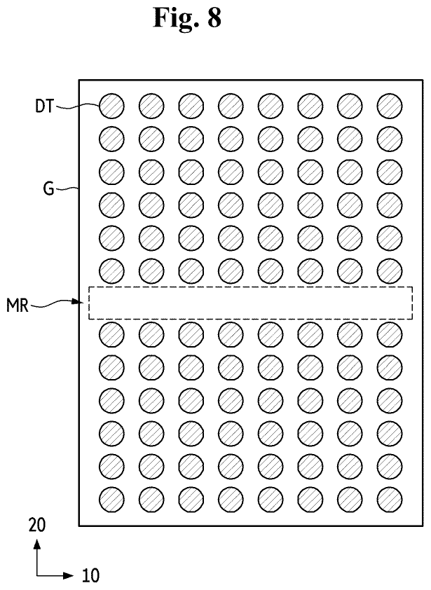

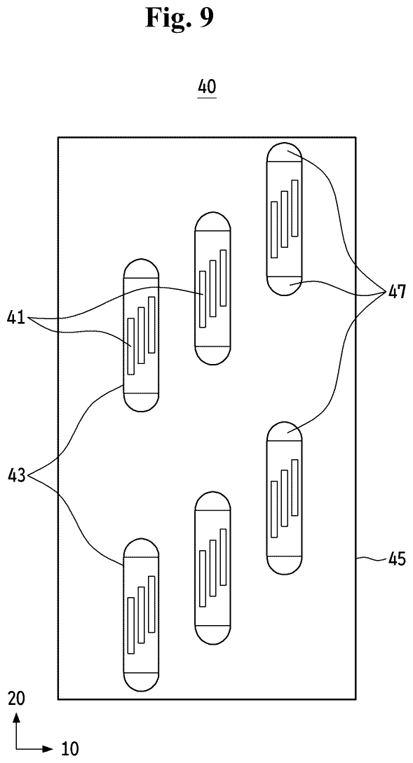

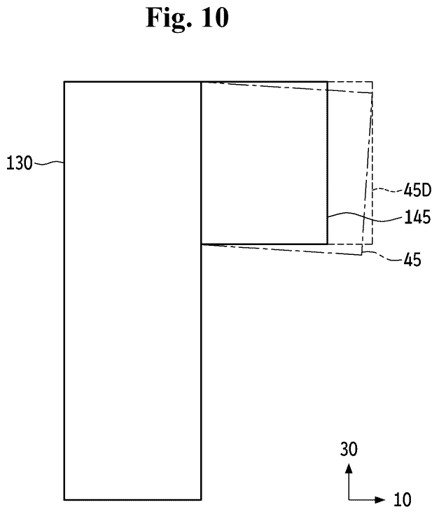

Also, FIG. 8 is a plan view for explaining a stain phenomenon of an inkjet head unit 40 according to a comparative example, FIG. 9 is a plan view for explaining the inkjet head unit 40, and FIG. 10 is a front view for explaining the inkjet head unit 140 of the substrate treating apparatus 100 and the inkjet head unit 40.

Referring first to FIGS. 8 through 10, in the inkjet head unit 40 of the comparative example, a plurality of packs 43 are provided on a carriage plate 45. A plurality of heads 41 are provided in one row in each pack 43. In other words, each head pack (41 and 43), which is a structure where multiple heads 41 and a pack 43 are integrated, according to the comparative example, includes only one row of heads 41 along a first direction 10 within one pack 43.

A plurality of head packs (41 and 43) of the comparative example have a limit in sufficiently lowering the distance between adjacent head packs (41 and 43) due to the presence of head holders 47. That is, since the head holders 47, which fix the corresponding head packs (41 and 43) to the carriage plate 45, require bearings and/or motors for the purpose of, for example, positional adjustment, the head holders 47 inevitably occupy space on the carriage plate 45. As a result, the plurality of head packs (41 and 43) arranged in a second direction 20 are inevitably spaced apart according to the size of the head holders 47.

Since the spacing between the heads 41 is relatively large in each head pack (41 and 43) of the comparative example, problems such as stains (e.g., spot mura, line mura, and/or region mura) may arise. That is, as illustrated in FIG. 8, on a substrate G where dotting points DT are provided, a region MR where a substrate treating liquid is not applied may occur.

To minimize such problems, a plurality of heads 41 provided in one pack 43 are arranged to be offset from each other in the second direction 20. However, to offset the plurality of heads 41, alignment tools such as adjustment screws may be needed to adjust the positions of the plurality of heads 41, resulting in an increase in the amount of work required for head alignment.

In addition, according to the comparative example, since the heads 41 provided in each pack 43 are arranged in a single row, the head holders 47 are provided for the corresponding packs 43. Therefore, compared to the first embodiment, the number of head holders 47 is doubled, inevitably increasing load. Accordingly, if the same number of heads 41 as in the first embodiment are provided, due to the additional components such as the head holders 47, there is a difference in critical load, making it difficult to install the inkjet head unit 40 on a single gantry, and thus requiring a dual gantry.

This is because, as illustrated in FIG. 10, if the carriage plate 45 of the inkjet head unit 40 is installed on a single gantry, the carriage plate 45 cannot be provided as designed, as indicated by reference numeral 45D, and due to sagging under the load, nozzles positioned on the right side are tilted downward, causing a change in distance along the first direction 10.

On the contrary, the first embodiment addresses the problems associated with the comparative example, thereby reducing the number of head holders 147 compared to the comparative example. Thus, the load of the inkjet head unit 140 installed on a carriage plate 145 may be reduced. Therefore, even if the same number of heads 141 are provided, the first embodiment allows the use of a single gantry without the need of a dual gantry.

When a gantry unit 130 is provided as a single gantry, rather than as a dual gantry, the configuration of the inkjet head unit 140 may be simplified. Since the load of the gantry unit 130, which occupies a large portion of the total load of the substrate treating apparatus 100, may also be lowered, the amount of work required to disassemble the substrate treating apparatus 100 for weight reduction during transport may be reduced. As a result, the setup period may be shortened, and in some embodiments, the substrate treating apparatus 100 may be shipped out without disassembly.

In addition, in the substrate treating apparatus 100, since a plurality of heads 141 arranged in the second direction 20 may be provided in two rows within each single pack 143, the heads 141 may be arranged adjacent to each other without interference by the head holders 147. Therefore, unlike the heads 41 of the comparative example that need to be offset within each single pack 43 to prevent stain phenomena, the heads 141 provided in each single pack 143 may be arranged side by side in the first direction 10 without being offset. That is, the center lines of the heads 141 may be aligned such that the center axes between first nozzles 140N may be aligned. Then, simply by offsetting a plurality of packs 143 from each other in the second direction 20, head alignment may be performed in units of the packs 143, rather than in units of the heads 141, greatly reducing the work time and workload for head alignment.

This will hereinafter be described in further detail.

Referring to FIGS. 2 through 7, the heads 141 of the inkjet head unit 140 may be aligned by the head alignment unit 160.

For convenience of description and understanding, it is assumed that a plurality of packs 143 are provided in multiple columns on the carriage plate 145 and include a first pack P1 provided in a first column, a second pack P2 provided in a second column, and a third pack P3 provided in a third column. It is also assumed that a plurality of heads 141 are provided in multiple rows and columns within each pack 143. Heads 141 arranged at the same position without offsetting may be defined as a single unit, and heads 141 in an M-th row within a pack 143 in an N-th column may be defined as heads HNM where M and N are both natural numbers). For example, referring to FIG. 4, heads 141 grouped in a first row within the first pack P1 may be defined as heads H11, and heads 141 grouped in a second row within the second pack P2 may be defined as heads H22.

In FIG. 4, a plurality of nozzles 140N are illustrated as being provided in one row within each head 141. However, this is merely exemplary, and various modifications are possible such as providing a plurality of nozzles 140N in two or more rows within each head 141.

The inkjet head unit 140 of the first embodiment may include heads 141, packs 143, a carriage plate 145, and head holders 147.

The heads 141 may include ports (not illustrated) to which the substrate treating liquid is supplied, and a plurality of nozzles 140N (see FIG. 4) for pixel printing on the substrate G. The heads 141 may be formed with the same size.

The heads 141 may each eject a specific color substrate treating liquid, such as, for example, red color ink, green color ink, or blue color ink, onto the substrate G. The nozzles 140N may be provided in multiple rows and/or columns in the order of red color ink, green color ink, and blue color ink.

A plurality of heads 141 may be provided in each pack 143. Unlike the inkjet head unit 40 of the comparative example, in the inkjet head unit 140 of the first embodiment, a structure may be provided in which the heads 141 may be arranged without interference by the head holders 147, thereby preventing or reducing the occurrence of stain phenomena (see “MR” in FIG. 8).

Specifically, a plurality of heads 141 may be provided along the first direction 10 within each pack 143, and unlike in the comparative example, may be arranged in two rows in the second direction 20, which is the direction in which the nozzles 140N are arranged.

Furthermore, in the substrate treating apparatus 100 according to the first embodiment, the gantry unit 130, which supports the heads 141, may be provided as a single gantry. For example, one end of the carriage plate 145 may be installed on the gantry unit 130, and the numbers of packs 143 and heads 141 installed on the carriage plate 145 may each be set not to exceed a critical load threshold such that the other end of the carriage plate 145, which is a free end, may be prevented from sagging relative to the installed end.

Here, the numbers of packs 143 and heads 141 may be set not to exceed the critical load, assuming that within each pack 143, multiple heads 141 are provided in two rows in the first direction 10. In other words, in order to prevent stain phenomena, at least two rows of heads 141 may be provided in each pack 143, and within a range that does not exceed the critical load threshold, a plurality of packs 143 and/or a plurality of heads 141 may be provided in a column direction.

For example, the packs 143 may be provided in four or fewer columns on the carriage plate 145, and multiple heads 141 may be provided in two rows and up to five columns within each pack 143.

Specifically, as illustrated in FIG. 4, three packs 143 may be provided on the carriage plate 145, and eight heads 141 may be provided in each pack 143.

In addition, multiple adjacent packs 143 may be arranged so that the center lines of their groups of heads 141 may be offset from each other in the second direction 20, as indicated by dashed lines. That is, in one pack 143, a plurality of heads 141 may be arranged in a straight line in each row without being offset from each other, and adjacent packs 143 may be offset from each other. Therefore, head alignment may be performed based on the packs 143, rather than based on the individual heads 141, thereby reducing the time required for aligning the inkjet head unit 140.

In the inkjet head unit 140 of the present embodiment, the nozzles 140N of the last or rear row of heads 141 of a pack 143 in the N-th column may overlap with the nozzles 140N of the first or front row of heads 141 of a pack 143 in an (N+1)-th column.

Specifically, as an example, referring to reference character A in FIG. 4, the nozzles 140N of the last or rear row of heads H11 in the first row within the first pack P1, which is in a first column on the carriage plate 145, may overlap with the nozzles 140N of the first or front row of heads H21 in the first row within the second pack P2, which is in a second column on the carriage plate 145.

As an example, referring to reference character B in FIG. 4, the nozzles 140N of the last or rear row of heads H12 in the second row within the first pack P1 may overlap with the nozzles 140N of the first or front row of heads H22 in the second row within the second pack P2.

Since there is no interference from the head holders 147, the heads 141 may be arranged close to each other in two rows within each pack 143. For example, the nozzles 140N of the first or front row of heads H12 in the second row within the first pack P1 in the first column may overlap with the nozzles 140N of the last or rear row of heads in the first row of a subsequent pack 143 or the last pack 143, e.g., heads H21 of the second pack P2 or heads H31 of the third pack P3.

As an example, referring to reference character C in FIG. 4, the nozzles 140N of the first or front row of heads H12 in the second row within the first pack P1 may overlap with the nozzles 140N of the last or rear row of heads H31 in the first row within the third pack P3, which is in the last column on the carriage plate 145. Thus, since there is no gap between the nozzles 140N in the second direction 20, stain phenomena as indicated by “MR” in FIG. 8 may be prevented.

The packs 143, which are each provided to group multiple heads 141 together, may be installed on the gantry unit 130 via the carriage plate 145.

Each of the packs 143 may expose multiple nozzles 140N on the lower surface thereof to eject the substrate treating liquid, and insertion holes (not illustrated) corresponding to the shape and number of the heads 141 may be formed to accommodate the heads 141. That is, one head 141 may be installed in each of the insertion holes such that the nozzles 140N may be exposed, but the present disclosure is not limited thereto.

The carriage plate 145, which is provided to allow the plurality of packs 143 to be installed on the gantry unit 130, may be formed in a frame structure and/or a box structure. That is, the carriage plate 145 may have various shapes and structures suitable for installation on the gantry unit 130.

In addition, the carriage plate 145 may include holes (not illustrated) for exposing the nozzles 140N, similar to or like the insertion holes of the packs 143. In some embodiments, a substrate treating liquid supply unit 150 may also be installed on the carriage plate 145.

The head holders 147 are components for fixing the packs 143 to the carriage plate 145, and the positions of the head holders 147 may be adjusted or controlled by holder driving units 147M. For example, the head holder 147 may each include holes (not illustrated) for fastening bolts, and the holder driving units 147M may each include a bearing and/or a motor, with known technologies applied thereto.

In the inkjet head unit 140, a plurality of heads 141 each having a plurality of nozzles 140N may be assembled into each pack 143 for alignment, in order to shorten the processing time. Head packs (141 and 143) assembled in this manner may be installed on the carriage plate 145 and then mounted on the gantry unit 130.

The head alignment unit 160 may automatically perform head alignment in units of the packs 143.

The head alignment unit 160 for aligning the inkjet head unit 140 will hereinafter be described. In some embodiments, the head alignment unit 160 may be removed after aligning the head packs (141 and 143). However, preferably, the head alignment unit 160 may remain on the carriage plate 145 to continuously fix the positions of the head packs (141 and 143), thereby allowing realignment without the need for reinstallation if post-assembly positional error occurs.

The head alignment unit 160 may rotate first ends of the packs 143 relative to second ends of the packs 143 to adjust the alignment, in a first rotational direction (i.e., a θ direction), of the packs 143. Additionally, the head alignment unit 160 may adjust the position of each of the second and third packs P2 and P3 in the second direction 20.

For example, the head alignment unit 160 may include a first motor unit 160M1, a second motor unit 160M2, and a third motor unit 160M3, and may adjust the placement, in the first rotational direction, and the positions, in the second direction 20, of the second and third packs P2 and P3 with respect to the first pack P1.

Referring to FIG. 5, the first motor unit 160M1 may push or pull the first pack P1 from the first end of the first pack P1 in the first direction 10 to rotate the first pack P1. For example, the first motor unit 160M1 may include a first motor 161 whose length is adjustable in the first direction 10.

Here, the center of the head holder 147 located at the second end of the first pack P1 serves as a first axis R1 for the rotation of the first pack P1. Accordingly, when the length of the first motor 161 is adjusted at the second end of the first pack P1 in the first direction 10, the first pack P1 may be pushed or pulled, thereby adjusting its placement in the first rotational direction.

Referring to FIG. 6, the second motor unit 160M2 may push or pull the second pack P2 from the first end of the second pack P2 in the first direction 10 to rotate the second pack P2, and may additionally push or pull the second pack P2 from the first or second end of the second pack P2 in the second direction 20.

For example, the second motor unit 160M2 may include a second motor 162 whose length is adjustable in the first direction 10, and a third motor 163 whose length is adjustable in the second direction 20.

First, the third motor 163 of the second motor unit 160M2 may push or pull the second pack P2 in the second direction 20 to adjust the position of the second pack P2 in the second direction 20. Thereafter, or therebefore, the second motor 162 may push or pull the second pack P2 in the first direction 10 to adjust the placement of the second pack P2 in the first rotational direction.

Here, the center of the head holder 147 located at the second end of the second pack P2 serves as a second axis R2 for the rotation of the second pack P2. Accordingly, when the length of the second motor 162 is adjusted at the first end of the second pack P2 in the first direction 10, the second pack P2 may be pushed or pulled, thereby adjusting the placement of the second pack P2 in the first rotational direction.

Referring to FIG. 7, the third motor unit 160M3 may push or pull the third pack P3 from the first end of the third pack P3 in the first direction 10 to rotate the third pack P3, and may additionally push or pull the third pack P3 from the first end or second end of the third pack P3 in the second direction 20.

For example, the third motor unit 160M3 may include a fourth motor 164 whose length is adjustable in the first direction 10, and a fifth motor 165 whose length is adjustable in the second direction 20.

First, the fifth motor 165 of the third motor unit 160M3 may push or pull the third pack P3 in the second direction 20 to adjust the position of the third pack P3 in the second direction 20. Thereafter, or therebefore, the fourth motor 164 may push or pull the third pack P3 in the first direction 10 to adjust the placement of the third pack P3 in the first rotational direction.

Here, the center of the head holder 147 located at the second end of the third pack P3 serves as a third axis R3 for the rotation of the third pack P3. Accordingly, when the length of the fourth motor 164 is adjusted at the first end of the third pack P3 in the first direction 10, the third pack P3 may be pushed or pulled, thereby adjusting the position of the third pack P3 in the first rotational direction.

According to this embodiment, since a plurality of heads 141 can be aligned in units of the packs 143 without the need to individually align the heads 141, the work for head alignment can be simplified. In addition, since the number of head holders 147 can be reduced, the load on the inkjet head unit 140 supported by the gantry unit 130 can be reduced. Therefore, the simplification of the substrate treating apparatus 100 can be achieved, reducing restrictions such as the requirement of a dual gantry. As a result, the installation work for the substrate treating apparatus 100 can be facilitated.

Although embodiments of the present disclosure have been described above with reference to the accompanying drawings, it will be understood by one of ordinary skill in the art that various modifications can be made without departing from the technical spirit or essential features of the present disclosure. Therefore, it should be understood that the above-described embodiments are illustrative in all respects and not restrictive.

What is claimed is:

1. A substrate treating apparatus comprising:
an inkjet head unit configured to eject a substrate treating liquid; and
a gantry unit configured to support the inkjet head unit,
wherein
the inkjet head unit comprises: a plurality of heads each provided with a plurality of nozzles; and a plurality of packs in each of which the heads are installed such that the nozzles are exposed, and
within each of the packs, a plurality of heads are provided in a first direction and a second direction, in which the nozzles are arranged.

2. The substrate treating apparatus of claim 1, wherein the heads are provided in two rows within each of the packs.

3. The substrate treating apparatus of claim 2, wherein
the packs are arranged to be offset from each other in the second direction and provided in multiple columns, and
multiple heads in the same row within each of the packs are arranged side by side without being offset in the first direction.

4. The substrate treating apparatus of claim 1, wherein the inkjet head unit further comprises a carriage plate on which the packs are provided and which is installed on the gantry unit.

5. The substrate treating apparatus of claim 4, wherein the inkjet head unit further comprises head holders configured to fix the packs to the carriage plate.

6. The substrate treating apparatus of claim 4, wherein
the gantry unit is provided as a single gantry,
one end of the carriage plate is installed on the single gantry, and
numbers of the packs and the heads installed on the carriage plate are set not to exceed a critical load threshold such that the other end of the carriage plate, which is a free end, is prevented from sagging relative to the installed end.

7. The substrate treating apparatus of claim 6, wherein the numbers of the packs and the heads, set not to exceed the critical load, are based on the heads being provided in two rows, such that a plurality of heads are provided in the first direction.

8. The substrate treating apparatus of claim 7, wherein
the packs are provided in four or fewer columns on the carriage plate, and
within each of the packs, a plurality of heads are provided in two rows and up to five columns.

9. The substrate treating apparatus of claim 4, wherein
the packs are arranged to be offset from each other in the second direction based on center lines of the heads, and
nozzles of a last row or rear row of heads in an M-th row within a pack in an N-th column on the carriage plate overlap with nozzles of a first row or front row of heads in an M-th row within a pack in an (N+1)-th column.

10. The substrate treating apparatus of claim 9, wherein nozzles of a first row or front row of heads in a second row of a pack in a first column on the carriage plate overlap with nozzles of a last row or rear row of heads provided in a first row within a pack in a rear column or a last column.

11. The substrate treating apparatus of claim 1, further comprising:
a head alignment unit configured to rotate first ends of the packs relative to second ends of the packs to adjust placement of the packs in a first rotational direction.

12. The substrate treating apparatus of claim 11, wherein
the heads are provided in two or more rows within each of the packs,
the packs comprise a first pack provided in an N-th column, a second pack provided in an (N+1)-th column, and a third pack provided in an (N+2)-th column, and
the head alignment unit adjusts the placement, in the first rotational direction, of the second and third packs relative to the first pack.

13. The substrate treating apparatus of claim 12, wherein the head alignment unit comprises: a first motor unit configured to push or pull the first pack from the first end of the first pack in a first direction to rotate the first pack; a second motor unit configured to push or pull the second pack from the first end of the second pack in the first direction to rotate the second pack; and a third motor unit configured to push or pull the third pack from the first end of the third pack in the first direction to rotate the third pack.

14. The substrate treating apparatus of claim 13, wherein
the head alignment unit adjusts positions of the second and third packs in the second direction,
the second motor unit pushes or pulls the second pack from the first end to the second end of the second pack in the second direction, and
the third motor unit pushes or pulls the third pack from the first end to the second end of the third pack in the second direction.

15. The substrate treating apparatus of claim 14, wherein
the first motor unit includes a first motor whose length is adjustable in the first direction,
the second motor unit includes a second motor whose length is adjustable in the first direction and a third motor whose length is adjustable in the second direction, and
the third motor unit includes a fourth motor whose length is adjustable in the first direction and a fifth motor whose length is adjustable in the second direction.

16. A substrate treating apparatus comprising:
an inkjet head unit configured to eject a substrate treating liquid provided as ink; and
a gantry unit configured to support the inkjet head unit and provided as a single gantry,
wherein
the inkjet head unit comprises: a plurality of heads each provided with a plurality of nozzles; a plurality of packs in each of which the heads are installed such that the nozzles are exposed; a carriage plate on which the packs are provided and which is installed on the gantry unit; head holders configured to fix the packs to the carriage plate; and a head alignment unit configured to rotate first ends of the packs relative to second ends of the packs to adjust placement of the packs in a first rotational direction,
the packs are arranged in three columns on the carriage plate and offset from each other based on center lines of the heads in a second direction, in which the nozzles are arranged, and comprise: a first pack provided in a first column; a second pack provided in a second column; and a third pack provided in a third column,
the heads are provided in two rows and three or more columns within each of the packs, and multiple heads located in the same row within each of the packs are arranged side by side in the first direction without being offset, and provided in up to five columns,
nozzles of a last row or subsequent row of heads in an M-th row within the first pack on the carriage plate overlap with nozzles of a first row or front row of heads in an M-th row within the second pack,
nozzles of a first row or preceding row of heads in a second row within the first pack on the carriage plate overlap with nozzles of a last row or rear row of heads in a first row within the third pack, and
the head alignment unit comprises: a first motor unit including a first motor whose length is adjustable in the first direction and configured to push or pull the first pack from a first end of the first pack in the first direction to rotate the first pack; a second motor unit including a second motor whose length is adjustable in the first direction, and a third motor whose length is adjustable in the second direction and configured to push or pull the second pack from a first end of the second pack in the first direction to rotate the second pack; and a third motor unit including a fourth motor whose length is adjustable in the first direction and a fifth motor whose length is adjustable in the second direction and configured to push or pull the third pack from a first end of the third pack in the first direction to rotate the third pack.

17. An inkjet head unit provided in a substrate treating apparatus, comprising:
a plurality of heads each provided with a plurality of nozzles; and
a plurality of packs in each of which the heads are installed such that the nozzles are exposed,
wherein a plurality of heads are provided within each of the packs along a first direction and a second direction, in which the nozzles are arranged.

18. The inkjet head unit of claim 17, wherein the heads are provided in two rows and in multiple columns within each of the packs.

19. The inkjet head unit of claim 18, wherein
the packs are arranged to be offset from each other in the second direction and provided in multiple columns, and
the heads located in the same row within each of the packs are arranged side by side without being offset with their center lines aligned.

20. The inkjet head unit of claim 17, further comprising:
a carriage plate on which the packs are provided and which is installed on a gantry unit; and
head holders configured to fix the packs to the carriage plate.
